(19) United States
(12) Patent Application Publication
(10) Pub. No.: US 2026/0143327 A1
(43) Pub. Date: May 21, 2026

(54) INTERNET PROTOCOL MULTIMEDIA SUBSYSTEM DE-REGISTRATION METHODS AND SYSTEMS

(71) Applicant: T-Mobile Innovations LLC, Overland Park, KS (US)

(72) Inventors: Anil Kumar MARIYANI, Bellevue, WA (US); Sean P. HOELZLE, Collegeville, PA (US); Subramania KAUSHIK, Bellevue, WA (US)

(21) Appl. No.: 18/953,340

(22) Filed: Nov. 20, 2024

(51) Int. Cl. H04W 8/12; H04L 65/1016; H04W 8/04; H04W 60/06; H04W 84/04

(52) U.S. Cl. CPC H04W 8/12; H04L 65/1016; H04W 8/04; H04W 60/06; H04W 84/042

(57) ABSTRACT

Methods and systems provided herein provide for IMS de-registration when a roaming network does not support voice over long term evolution (VoLTE) or voice over new radio (VoNR). An IMS de-registration system can trigger functionality in a home subscriber server and/or a unified data management (UDM) function to trigger de-registration from the IMS. The system may trigger identification of a non-voice over packet switched (non-VoPS) network and further trigger de-registration based on this identification.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G new radio (NR) and millimeter wave (mm-wave) networks, as well as 4G long-term evolution (LTE) access nodes and older legacy protocols.

During the evolution of newer wireless RATs, improved voice services have become available. For example, with 4G networks, Voice over Long-Term Evolution (VoLTE), which is an LTE high speed wireless communication standard for voice calls became available. Further, with the development of 5G networks, Voice over New Radio (VoNR), which fully utilizes the 5G standalone (SA) core network was developed. In either case, to support VoLTE or VoNR, a network must be a Voice over Packet Switched (VoPS) network utilizing an IP Multimedia Subsystem (IMS).

When a wireless device or user equipment (UE) having a home public land mobile network (PLMN) that is a VoPS network attaches to a partner roaming PLMN, the roaming PLMN may not be a VoPS network. Thus, the roaming PLMN may not support VoLTE or VoNR and may be unable to provide this voice service to the wireless device. Despite this fact, when the home PLMN is a VoPS network, the IMS of the home network continues to retain the IMS registration status of the wireless device.

The maintenance of an incorrect registration status for a wireless device connected to a roaming PLMN results in multiple problems. For example, maintaining an incorrect status may result in voice calls directed to the wireless device (mobile terminated (MT) calls) to be forwarded directly to voice mail. Further, incorrect registration status can cause short messaging service (SMS) messages to be delayed. Accordingly, a solution is needed for overcoming these problems.

### Overview

Exemplary embodiments provided herein include a method, system, processing node, and/or non-transitory computer-readable medium for Internet protocol multimedia subsystem (IMS) de-registration for a wireless device. In one exemplary embodiment, a method is provided. The method includes receiving at home public land mobile network (PLMN), a notification that a wireless device has attached to a roaming PLMN. The method further includes determining at the home network that the roaming PLMN is not a voice over packet switched (VoPS) network. The method further includes deregistering the wireless device from an IMS of the home network.

Embodiments disclosed herein further include a system for performing IMS de-registration. The system includes a memory storing data and instructions and at least one processor executing the stored instructions to perform multiple operations. The operations include receiving at a home PLMN, a notification that a wireless device has attached to a roaming PLMN. The operations additionally include determining at the home PLMN that the roaming PLMN is not a VoPS network; and deregistering the wireless device from an internet protocol multimedia subsystem (IMS) of the home PLMN.

In a further embodiment, a non-transitory computer-readable medium stores instructions executed by a processor to perform multiple operations. The operations include receiving a notification that a wireless device has attached to a roaming PLMN and determining that the roaming PLMN is not a VoPS network. The operations additionally include deregistering the wireless device from the IMS.

Further embodiments include home subscriber servers (HSSs), unified data management functions (UDMs) and processing nodes performing the operations described above.

### BRIEF DESCRIPTION OF THE DRAWINGS

FIG. 1A depicts an exemplary environment for an IMS de-registration system in accordance with an embodiment.

FIG. 1B depicts an alternate exemplary environment for an IMS de-registration system in accordance with an embodiment.

FIG. 2 depicts an IMS de-registration system in accordance with an embodiment.

FIG. 3 depicts a method for performing IMS de-registration in accordance with an embodiment.

FIG. 4 depicts a further exemplary method for performing IMS de-registration in accordance with an embodiment.

FIG. 5 depicts a further exemplary method for performing IMS de-registration in accordance with an embodiment.

FIG. 6 depicts an exemplary method for performing IMS de-registration in an exemplary environment in accordance with an embodiment.

FIG. 7 depicts an additional exemplary method for performing IMS de-registration in an additional exemplary environment in accordance with an embodiment.

### DETAILED DESCRIPTION

In embodiments disclosed herein, functionality for de-registration from a network internet protocol multimedia subsystem (IMS) is provided. In scenarios described herein, by de-registering roaming wireless devices from a home IMS, difficulties are avoided such as directing of mobile terminated (MT) calls directly to voicemail and delays in MT short messaging service (SMS) delivery.

Currently, when a wireless device or user equipment (UE) attaches to a non-voice over packet switched (non-VoPS) roaming partner network through a mobility management entity (MME) or access and mobility function (AMF) of the roaming network, a home subscriber service (HSS) continues to retain the IP Multimedia subsystem (IMS) registration status despite this registration being ineffective for the partner roaming network. This is because, although the data network is aware that the subscriber has entered a roaming network, the IMS network is not aware that the subscriber utilizing the wireless device has moved into a roaming network. Embodiments provided herein ensure that the IMS becomes aware.

As set forth herein, maintaining an incorrect IMS registration status could lead to MT calls going into voicemail and delays in MT SMS delivery over the SGd interface used for signaling between the MME and the short message service center (SMSC). SMSC design in a majority of networks prefers internet protocol IP SMS delivery and thus the incorrect registration state causes delays in MT SMS delivery.

In embodiments provided herein, IMS de-registration functionality is provided. In some embodiments, the functionality is provided partially or fully in a home subscriber server (HSS) of the home public land mobile network (PLMN) of the wireless device. In other embodiments, the functionality may be provided in both the HSS and the unified data management (UDM). Alternatively or additionally, the functionality may be provided in a processing node communicating with components of the home PLMN of the wireless device.

In embodiments provided herein, VoPS identification logic detects whether a wireless device has attached to a non-VoPS network. For example, functionality in the HSS may detect an LTE attach on a Non-VoLTE PLMN. Further, the VoPS identification logic may determine if an active IMS registration exists. For example, the HSS identifies an active IMS registration for the wireless device from a VoLTE supported network. When the registration is detected, IMS de-registration logic triggers the HSS to send an IMS de-registration message over the CxRTR interface towards the IMS.

The VoPS identification logic can be implemented in multiple ways. For example, a database containing a list of non-VoPS supported roaming partner PLMNs can be maintained and accessed upon notification of the attach request. As a further option, the interface between the roaming PLMN and the home PLMN can be enhanced to include additional data that identifies the VoPS support capability of the roaming PLMN when parsed by the home PLMN.

Accordingly, by identifying the VoPS capability of the roaming network and triggering IMS de-registration when the roaming network is not a VoPS network, various advantages are achieved. For example MT call drops and MT SMS delivery delays are reduced.

In addition to the systems and methods described herein, non-transitory computer-readable mediums may store the operations for the instructions or methods. Further, processing nodes on the network may execute the instructions or methods. The processing node may incorporate a processor included in the HSS, the UDM, an access and mobility management function (AMF), a mobility management entity (MME), and/or a processor included in any controller node in the wireless network.

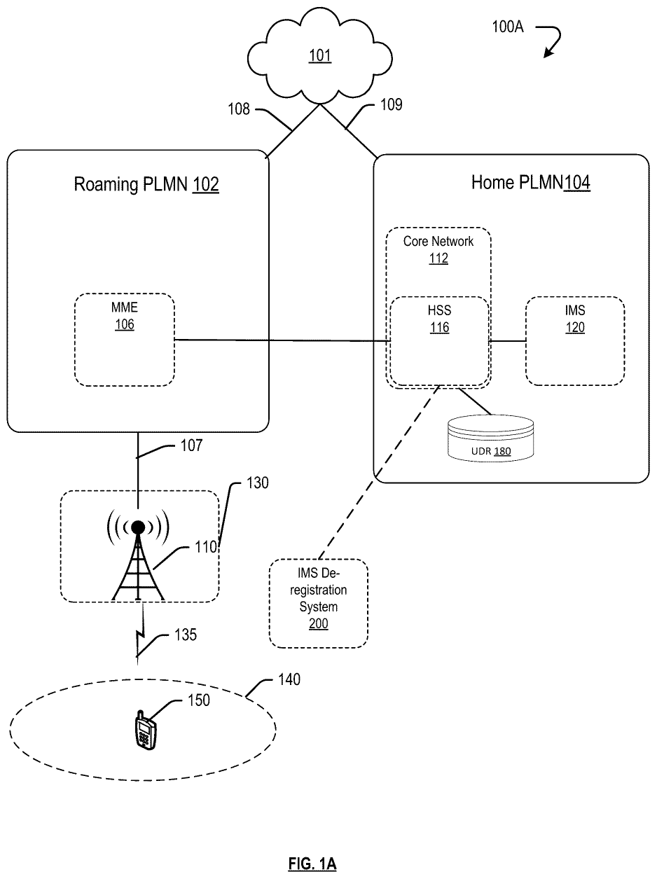

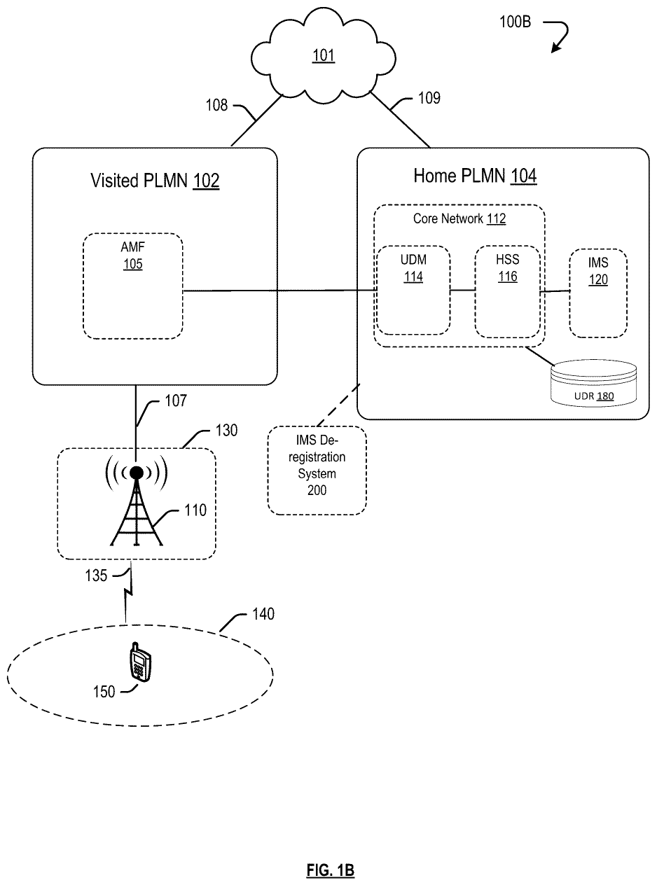

FIG. 1A depicts an exemplary 4g LTE environment 100A for implementing an IMS de-registration system 200. Environment 100A comprises a communication network 101, a roaming PLMN 102, a home PLMN 104, and a radio access network (RAN) 130 including at least an access node 110. A wireless device 150 is located in a coverage area 140 and communicates with the access node 110 over communication link 135. Although only one wireless device 150 is shown, it should be understood that any number of wireless devices could be included. The home PLMN 104 includes a core network 112 having an HSS 116. The home PLMN further includes a unified data repository (UDR) 180 an IMS 120. The roaming PLMN 102 as illustrated includes a mobility management entity (MME) 106. While both the visited PLMN 102 and the home PLMN 104 contain additional features, these features are omitted for the purposes of explanation and simplification.

Further, the IMS de-registration system 200 interacts with the home PLMN 104 to determine the capabilities of the visited PLMN 102. For example, the IMS de-registration system 200 determines or configures the HSS 116 to determine whether the visited PLMN 102 is a VoPS network. When the visited PLMN is not a VoPS network and the wireless device 150 is registered with the IMS 120, the IMS de-registration system 200 triggers de-registration of the wireless device 150 from the IMS 120.

The IMS de-registration system 200 is illustrated as communicating with or incorporated in the core network 112 of the home PLMN 104. In some embodiments, the IMS de-registration system 200 may be incorporated in or in direct communication with the HSS 116.

In operation, the wireless device 150 sends an attach request over wireless communication link 135 to an access node 110 of the RAN 130, which reaches the MME 106 of the visited PLMN 102. In response to the attach request, the MME 106 communicates with the home PLMN 104, or more specifically, with the HSS 116 of the home PLMN 104.

The RAN 130 can include various access network functions and devices disposed between the core network 112 and the wireless device 150. For example, the RAN 130 includes at least an access node (or base station), such as an eNodeB and/or a next generation NodeB (gNodeB) 110 communicating with the wireless device 150. Further, either of core network 112 and RAN 130 can include one or more of a local area network, a wide area network, and an internetwork (including the Internet) and be capable of communicating signals and carrying data, for example, to support voice, push-to-talk, broadcast video, and data communications by the wireless device 150.

Access node 110 can be any network node configured to provide communication between the wireless device 150 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is an eNB or gNB. However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 150 are illustrated in FIG. 1, any number of access nodes 110 and wireless devices 150 can be implemented within environment 100A.

As further described herein, by utilizing antennas, access node 110 can deploy a communication link 135 using one or more frequency bands over one or more coverage areas 140. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 150 may be any device, system, combination of devices, or other such communication platform capable of communicating wirelessly with access node 110 using one or more frequency bands deployed therefrom. Wireless device 150 may be, for example, a mobile phone, a wireless phone, a wireless modem, a personal digital assistant (PDA), a voice over internet protocol (VoIP) phone, a voice over packet (VOP) phone, a soft phone as well as other types of devices or systems that can exchange audio or data via access node 110. The wireless device 150 can be end-user wireless devices (e.g., user equipment (UEs)) utilizing communication links 135, which may operate based on 6G, 5G new radio (NR), 4G long term evolution (LTE), or any other suitable type of ratio access technology (RAT).

Communication links 107, 108, and 109 can use various communication media, such as air, space, metal, optical fiber, or some other signal propagation path including combinations thereof. Communication links 107, 108, and 109 can be wired or wireless and use various communication protocols such as Internet, Internet protocol (IP), local-area network (LAN), optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol as described herein. Communication links 107, 108, and 109 can be a direct link or might include various equipment, intermediate components, systems, and networks. Communication links 107, 108, and 109 may comprise many different signals sharing the same link.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices. Wireless network protocols can comprise MBMS, code division multiple access (CDMA) 1x RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and/or other wireless network protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM), and/or other wired network protocols. Communication network 101 can also comprise additional base stations, controller nodes, telephony switches, internet routers, network gateways, computer systems, communication links, or some other type of communication equipment, and combinations thereof.

Other network elements may be present in environment 100A to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

FIG. 1B depicts an exemplary 5g NR environment 100B for implementing an IMS de-registration system 200. The environment 100B may be similar to the above-described environment 100A in that like reference numerals refer to like elements. Thus, environment 100B comprises a communication network 101, a visited PLMN 102, a home PLMN 104, and a radio access network (RAN) 130 including at least an access node 110. A wireless device 150 is located in a coverage area 140 and communicates with the access node 110 over communication link 135. Although only one wireless device 150 is shown, it should be understood that any number of wireless devices could be included.

The home PLMN 104 includes a core network 112 having a UDM 114 and an HSS 116. The home PLMN 104 further includes an IMS 120 and a UDR 180. The visited PLMN 102 as illustrated includes an AMF 105. While both the visited PLMN 102 and the home PLMN 104 contain additional features, these features are omitted for the purposes of explanation and simplification.

Further, the IMS de-registration system 200 interacts with the home PLMN 104 to determine the capabilities of the visited PLMN 102. For example, the IMS de-registration system 200 determines or configures the UDM 114 and/or HSS 116 to determine whether the visited PLMN 102 is a VoPS network. When the visited PLMN is not a VoPS network and the wireless device is registered with the IMS 120, the IMS de-registration system 200 triggers de-registration of the wireless device 150 from the IMS 120 through the HSS 116.

The IMS de-registration system 200 is illustrated as communicating with or incorporated in the core network 112 of the home PLMN 104. In some embodiments, the IMS de-registration system 200 may be incorporated in or in direct communication with the HSS 116 and/or UDM 114.

In operation, the wireless device 150 sends an attach request over wireless communication link 135 to an access node 110 of the RAN 130, which reaches the AMF 105 of the visited PLMN 102. In response to the attach request, the AMF 105 communicates with the home PLMN 104, or more specifically, the UDM 114 of the home PLMN 104.

The core network 112 includes a service based architecture (SBA) architecture, in which service-based interfaces may be utilized between control plane functions, while multiple user plane functions connect over point-to-point link. Each network function, such as the UDM 114 and HSS 116 exposes its functionality through a Service-Based Interface (SBI). The RAN 130, access node 110, wireless device 150, communication network 101, and communication links 107, 108, may be substantially as described above with respect to FIG. 1A.

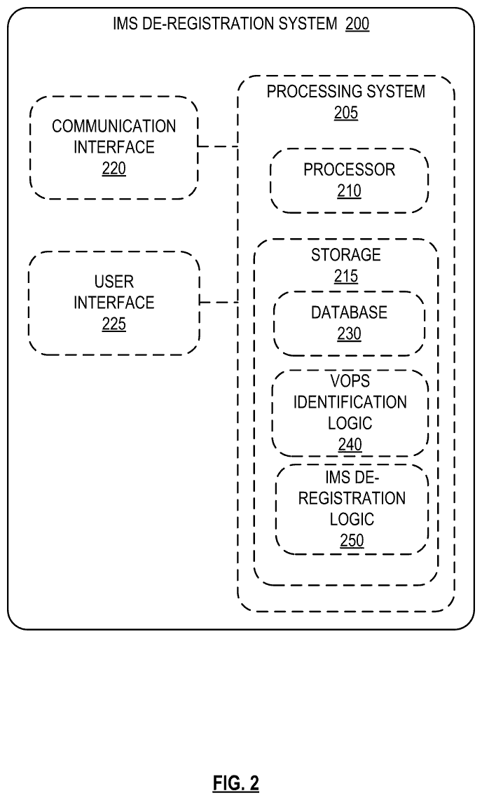

FIG. 2 illustrates an IMS de-registration system 200 in accordance with embodiments described herein. The components described herein are merely exemplary as many different configurations for the IMS de-registration system 200 may be implemented. The IMS de-registration system 200 may be configured to perform the methods and operations disclosed herein to dynamically trigger identification of the capabilities of a visited PLMN 102 further triggering de-registration of the wireless device 150 with the IMS 120 when the visited PLMN is not a VoPS network.

Thus, the IMS de-registration system 200 may communicate with core network components such as the UDM 114 and/or HSS 116 to cause de-registration of a wireless device 150 from the IMS 120 when the wireless device attaches 150 to a network that is not a VoPS network. In the disclosed embodiments, the IMS de-registration system 200 may be integrated with the core network 112, for example with the HSS 116 and/or UDM 114, or may be an entirely separate component capable of communicating with the core network 112. Further, the components of the IMS de-registration system 200 may be distributed so that one or more components are located within the HSS 116 and/or UDM 114, and/or a separate processing node in communication with or integrated with the core network 112.

The IMS de-registration system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, VoPS identification logic 240 may be operable to identify whether a visited PLMN 102 is a VoPS network, i.e., a network that supports VoLTE or VoNR. IMS de-registration logic 250 may be utilized by and/or incorporated in the HSS 116 to ensure that a wireless device 150 registered with the IMS 120 is de-registered from the IMS 120 when the visited PLMN 102 is not a VoPS network and does not support VoLTE or VoNR. Further, the storage device 215 may include a database 230. The database 230 may store partner network information, such as list of partner networks that do not support VoLTE or VoNR. To perform the above-described operations, the VoPS identification logic 240 and the IMS de-registration logic 250 may be executed by the processor 210 to manage de-registration of wireless device 150 from the IMS 120.

Processor 210 may be a microprocessor and may include hardware circuitry and/or embedded codes configured to retrieve and execute software stored in storage device 215. The IMS de-registration system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the IMS de registration system 200 and receive data or information from other system components. User interface 225 may include hardware components, such as touch screens, buttons, displays, speakers, etc. The IMS de-registration system 200 may further include other components such as a power management unit, a control interface unit, etc. The location of the IMS de-registration system 200 may depend upon the network architecture. As set forth above, the IMS de-registration system 200 may be located in the core network 112, in a separate processing node, in the HSS 116, in multiple locations such as the HSS 116 and the UDM 114, or may be an entirely discrete component. Further, although shown as a single integrated system, the function of VoPS identification and IMS de-registration may be separated and be disposed in separate locations.

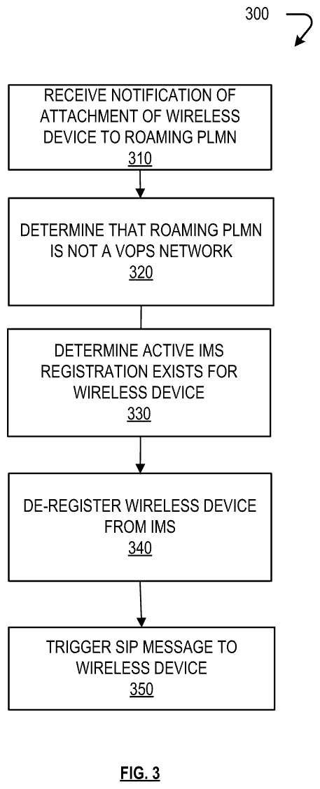

FIG. 3 illustrates a generalized exemplary method 300 for de-registering a wireless device from an IMS 120 in accordance with embodiments provided herein using the IMS de-registration system 200. Method 300 may be performed by a processor, for example, the processor 210 included in the IMS de-registration system 200, or a processor in the HSS 116 and/or UDM 114. For discussion purposes, as an example, method 300 is described as being performed by the processor 210 of the IMS de-registration system 200. However, it should be understood that the steps illustrated in FIG. 3 are performed in conjunction with the HSS 116 and the processor 210 may, in fact, be incorporated in the HSS 116. Further, when the home network has a UDM 114, a processor of the UDM 114 may perform steps of the method of FIG. 3.

Method 300 starts in step 310, in which the processor 210 receives notification of attachment of a wireless device 150 to a roaming PLMN 102. The PLMN 102 may be or include a PLMN utilizing legacy technologies and may not support VoLTE or VoNR. Further, the PLMN 102 may be or include a non-terrestrial network or a satellite network supporting only data and text services, but not voice services.

In step 320, the processor 210 determines that the visited PLMN 102 is not a VoPS network, i.e, the visited PLMN 102 does not support VoNR or VoLTE. This determination may be made in at least two different ways. First the UDM 114 or HSS 116 may maintain a list of non-VoPS partner networks that do not support VoNR or VoLTE and the processor 210 may consult this list to determine if the visited PLMN 102 is a VoPS network. The list may be stored on and accessed from the UDR 165. Alternatively, during the attach process, information about the roaming PLMN may be transported that enables identification of the roaming PLMN 102 as a non-VoPS network. The interfaces between the MME 106 and HSS 116 and/or the AMF 105 and the UDM 114 may be enhanced to provide this information to the processor 210.

Upon determining that the roaming PLMN is not a VoPS network, the processor 210 determines in step 330 that the wireless device 150 is registered with the IMS 120 based on contents of a database and triggers de-registration of the wireless device 150 from the IMS in step 340. The UDM 114 and/or HSS 116 may maintain registration status for each wireless device 150 in a database, for example at the UDR 165 or at the HSS 116, and the information in the database becomes stale when the wireless device 150 moves to network without VoLTE or VoNR capabilities. Upon triggering of the de-registration in step 340, the HSS 116 may send a deregistration message or a detach message towards the IMS 120.

Finally, in step 350, the processor 210 triggers a session initiation protocol (SIP) message to the wireless device 150. As a result of this message, a data session will be maintained, but no voice session will be offered.

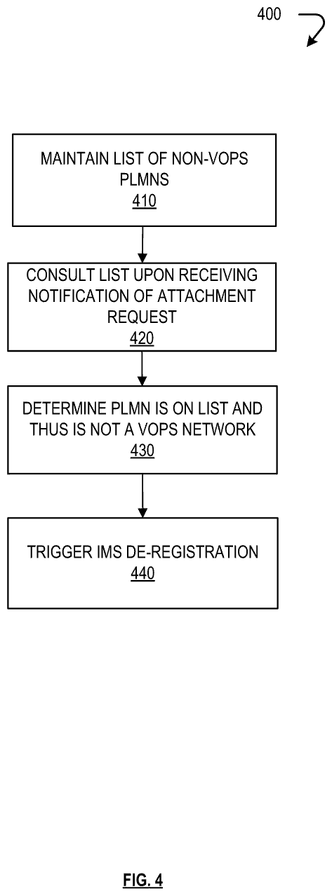

FIG. 4 depicts a further exemplary method 400 for triggering IMS de-registration in accordance with embodiments disclosed herein. Method 400 may be performed by any suitable processor discussed herein, for example, the processor 210 included in the IMS de-registration system 200 or in the UDM 114 and/or the HSS 116. For discussion purposes, as an example, method 400 is described as being performed by the processor 210 included in the IMS de-registration system 200, which may be wholly or partially incorporated in the HSS 116 and/or UDM 114.

Method 400 starts in step 410, in which the processor 210 maintains a list of non-VoPS partner PLMNs. The processor 210 may maintain this list in a database, for example, the processor 210 may maintain a list of Non-VoLTE or Non-VoNR roaming partner PLMN identifiers (IDs) in a global configuration table on 4G or 5G unified data repository (UDR) database 165. The list may be compiled based on an evaluation of all partner PLMNs designated as roaming PLMNs by the home PLMN 104.

In step 420, the processor 210 may trigger consultation of the list of non-VoPS PLMNs upon receiving notification of an attachment request from the wireless device 150. Thus, when a wireless device 150 attaches to a roaming PLMN 102, the processor 210 receives a notification of the attachment and identification of the roaming PLMN 102. The processor 210 may then trigger the HSS 116 or UDM 114 to consult the stored list at the UDR.

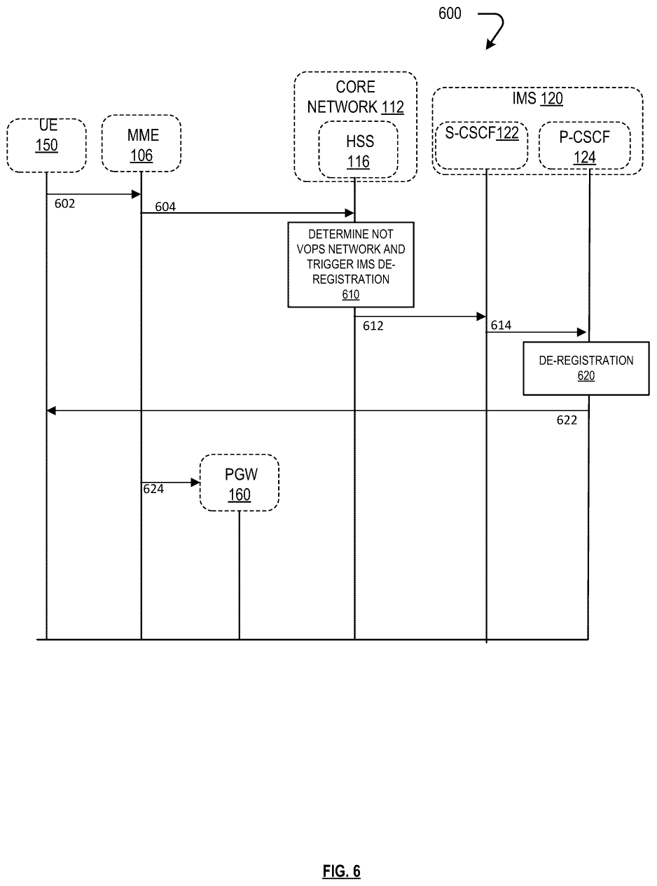

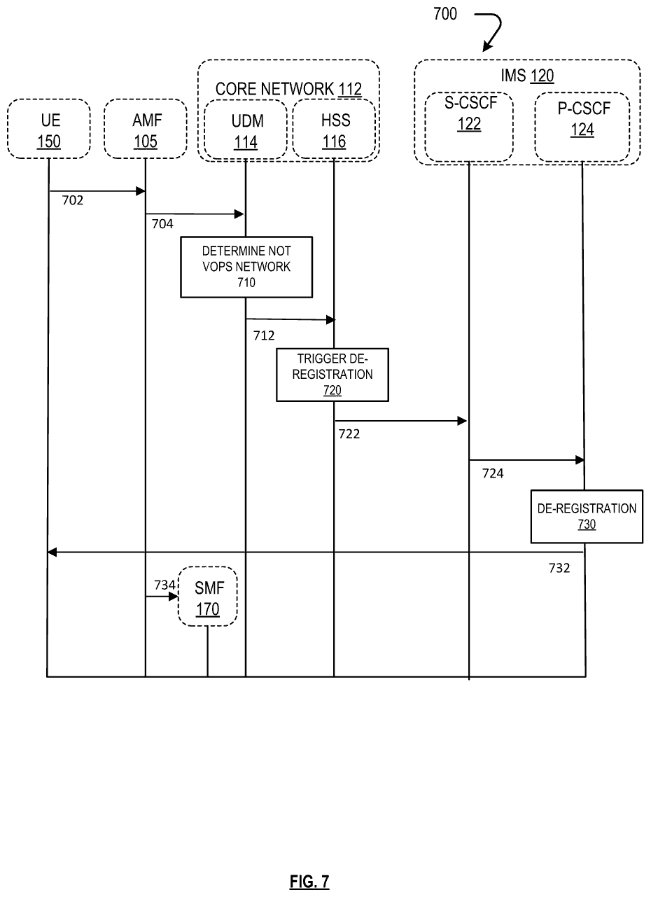

In step 430, the processor 210 determines that the roaming PLMN 102 is on the stored list and is thus not a VoPS network. Accordingly, the roaming PLMN 102 does not support VoLTE or VoNR and this is determined based on a stored list or lookup table. As a result of this determination, the processor 210 triggers IMS de-registration in step 440. The de-registration process may occur as set forth above with respect to FIG. 3 and further as described below with respect to FIGS. 6 and 7.

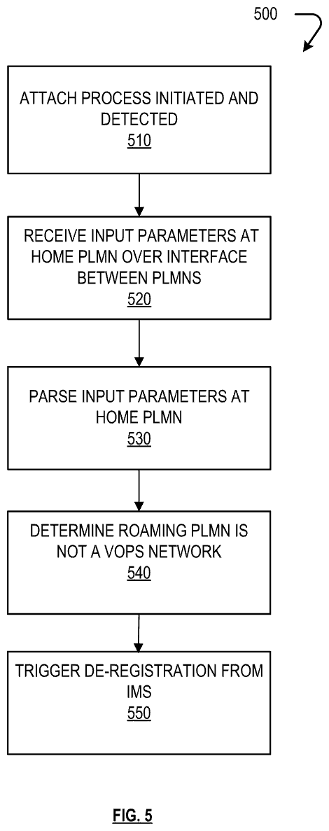

FIG. 5 depicts an additional exemplary method 500 for triggering IMS de-registration in accordance with embodiments disclosed herein. Method 500 may be performed by any suitable processor discussed herein, for example, the processor 210 in the IMS de-registration system 200, which may be wholly or partially incorporated in the UDM 114 and/or HSS 116. For discussion purposes, as an example, method 500 is described as being performed by the processor 210 included in the IMS de-registration system 200.

In step 510, the wireless device 150 initiates an attach process to the roaming PLMN 102 and the attachment is detected by the processor 210. In step 520, the processor 210 extracts the input parameters over the interface between the roaming PLMN 102 and the home PLMN 104.

In step 530, the processor 210 parses the input parameters. For example, with respect to the embodiment of FIG. 1A, in the 4G environment, the MME 106 sends the parameters over the S6a interface between the MME 106 and the HSS 116. In the 5G environment illustrated in FIG. 1B, the AMF 105 sends the parameters to the UDM 114 over the N8 interface. In either case, the processor 210 triggers the UDM 114 or the HSS 116 to parse the input parameters.

Accordingly, in step 540, based on the parsed input parameters, the processor 210 identifies VoPS capabilities during the attach process. In the displayed scenario, the processor 210 determines in step 540 that the roaming PLMN 102 is not a VoPS PLMN and thus does not support VoNR or VoLTE. Thus, the determination is made based on information in the notification received from the AMF 105 or MME 106.

Finally, based on the determination in step 540, the processor 210 triggers IMS de-registration in step 550. For example, the processor 210 notifies the UDM 114 or HSS 116 that the roaming PLMN is not a VoPS network in order to trigger IMS de-registration during which the HSS 116 sends an IMS deregistration message or IMS deregistration request.

FIG. 6 illustrates a method 600 for IMS de-registration triggered by the IMS de-registration system 200 in a 4G LTE environment such as that displayed in FIG. 1A. The method illustrates interactions between the wireless device 150, MME 106, packet gateway 160, core network 112 including HSS 116, and the IMS 120. The IMS 120 is illustrated as including a serving call session control function (S-CSCF) 122 and a proxy call session control function (P-CSCF) 124. It should be noted that other components may participate in the process have been omitted for the purposes of explanation and simplification. As explained above, the IMS de-registration system 200 may be a discrete node operating in conjunction with the displayed components. The IMS de-registration system 200 may alternatively be partially or wholly incorporated in the HSS 116.

In step 602, the wireless device 150 attaches to the roaming PLMN 102 by sending an attach request to the MME 106 using a non access stratum (NAS) layer to manage the establishment of communication sessions and for maintaining continuous communications with the wireless device 150 as it moves.

The MME 106 transmits the request to the HSS 116 at the core network 112 in step 604 over an S6A interface between MME 106 and HSS 116. The S6A interface is utilized for authentication, location and service information about the subscriber of the wireless device 150. . Further, in embodiments disclosed herein, such as the embodiment of FIG. 5, the S6A interface may be enhanced to provide data related to the roaming PLMN 102.

In step 610, the IMS deregistration system 200 triggers the HSS 116 to determine that the roaming PLMN 102 is not a VoPS network. Based on the determination that the roaming PLMN 102 is not a VoPS network and therefore does not support VoLTE, the HSS 116 sends a de-registration request in step 612 towards the IMS 120. More specifically, the HSS 116 sends a de-registration request to the S-CSCF 122 over a CxRTR interface. The receipt of the deregistration request at the S-CSCF 122 triggers forwarding of the request to the P-CSCF 124 as a SIP message in step 614. As a result, in step 620, the IMS 120 de-registers the wireless device 150. The IMS 120 sends a SIP message to the wireless device 150 in step 622. In step 624, once the wireless device 150 is de-registered from the IMS, the MME 106 enables data services, but disables voice services through the packet gateway 160.

FIG. 7 depicts an additional exemplary method 700 for IMS de-registration in a 5G NR environment such as that shown in FIG. 1B. The method illustrates interactions between the wireless device 150, AMF 105, session management function (SMF) 170, core network 112 including UDM 114, HSS 116, and the IMS 120. The IMS 120 is illustrated as including a serving call session control function (S-CSCF) 122 and a proxy call session control function (P-CSCF) 124. It should be noted that other components may participate in the process but have been omitted for the purposes of explanation and simplification. As explained above, the IMS de-registration system 200 may be a discrete node operating in conjunction with the displayed components. The IMS de-registration system 200 may be partially or wholly incorporated in the UDM 114 and/or HSS 116.

In step 702, the wireless device 150 attaches to the roaming PLMN 102 by sending an attach request to the AMF 105 using a NAS layer to manage the establishment of communication sessions and for maintaining continuous communications with the wireless device 150 as it moves.

The AMF 105 transmits the request to the UDM 114 at the core network 112 in step 704 over an N8 interface between the AMF 105 and the UDM 114. The N8 interface is utilized to transmit subscriber data between the AMF 105 and UDM 114. Further, in embodiments disclosed herein, such as the embodiment of FIG. 5, the N8 interface may be enhanced to provide data related to the roaming PLMN 102.

In step 710, the IMS deregistration system 200 triggers the UDM 114 to determine that the roaming PLMN 102 is not a VoPS network and thus, does not support VoLTE or VoNR, The UDM 114 shall be capable of notifying the HSS 116 of the non VoNR attach either on any vendor specific proprietary network interfaces or 3GPP based user data interworking, coexistence and migration (UDICOM) interface towards the HSS 116. Based on this determination, of the non-VoPS network that does not support VoNR, in step 712, the UDM 114 notifies the HSS 116. In step 712, the IMS deregistration system 200 triggers the HSS 116.

In step 720, the IMS de-registration system 200 triggers deregistration from the HSS 116. Accordingly, the HSS 116 sends a deregistration message to the IMS 120. More specifically, the HSS 116 sends a de-registration request to the S-CSCF 122 over a CxRTR interface in step 722. The HSS 116 shall also be capable of de-registration on a service based interface (SBI) HTTP2 N70 interface between the HSS 116 and the S-CSCF 122.

Accordingly, the HSS 116 determines that a 5G attach has occurred on the UDM 114 by a Non-VoLTE, non-VoNR roaming partner PLMN 102. Further, the UDM 114 sends updates to the HSS 116, which may be sent on a vendor proprietary network interfaces or on a service based interface (SBI) such as the user data interworking, coexistence and migration (UDICOM) interface towards the HSS 116. Thus, the HSS 116 is capable of identifying 5G attach on the UDM 114 by a non-VoLTE/non-VoNR roaming partner and perform IMS De-registration towards the IMS 120.

The receipt of the de-registration request at the S-CSCF 122 triggers forwarding of the request to the P-CSCF as a SIP message in step 724. As a result, in step 730, the IMS 120 de-registers the wireless device 150. The IMS 120 sends a SIP message to the wireless device 150 in step 732. In step 734, once the wireless device 150 is de-registered from the IMS, the AMF 105 enables data services, but disables voice services through the SMF 170.

Accordingly, as set forth above, embodiments provide for IMS de-registration are disclosed. In some embodiments, methods 300, 400, 500, 600, and 700 may include additional steps or operations and additional network components. Furthermore, the methods may include steps shown in each of the other methods. Additionally, the order of steps shown is merely exemplary and the steps may be re-ordered as appropriate. As one of ordinary skill in the art would understand, the methods 300, 400, 500, 600, and 700 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving at home public land mobile network (PLMN), a notification that a wireless device has attached to a roaming PLMN;
determining at the home network that the roaming PLMN is not a voice over packet switched (VoPS) network; and
deregistering the wireless device from an internet protocol multimedia subsystem (IMS) of the home network.

2. The method of claim 1, wherein the notification is received by a home subscriber server (HSS) of the home PLMN.

3. The method of claim 2, wherein the HSS of the home PLMN determines the roaming PLMN is not a VoPS network.

4. The method of claim 3, wherein the HSS utilizes a lookup table for the determination.

5. The method of claim 3, wherein the HSS makes the determination based on the notification.

6. The method of claim 3, further comprising sending an IMS deregistration request from the HSS to a serving call session control function (S-CSCF) of the IMS.

7. The method of claim 1, wherein the notification is received at a unified data management (UDM) function of the home PLMN.

8. The method of claim 7, wherein the UDM determines the roaming PLMN is not a VoPS network.

9. The method of claim 8, further comprising notifying a home subscriber server (HSS) that the roaming PLMN is not a VoPS network.

10. The method of claim 9, further comprising sending an IMS deregistration message from the HSS to a serving call session control function (S-CSCF) of the IMS.

11. The method of claim 1, further comprising maintaining a data session for the wireless device.

12. A system comprising:
a memory storing data and instructions; and
a processor executing the stored instructions to perform operations including:
receiving at a home public land mobile network (PLMN), a notification that a wireless device has attached to a roaming PLMN;
determining at the home PLMN that the roaming PLMN is not a voice over packet switched (VoPS) network; and
deregistering the wireless device from an internet protocol multimedia subsystem (IMS) of the home PLMN.

13. The system of claim 12, wherein the determination is made using a lookup table.

14. The system of claim 12, wherein the determination is made based on information in the notification.

15. The system of claim 12, further comprising a communication interface for communicating with a home subscriber server (HSS) of the home network.

16. The system of claim 12, wherein the operations include terminating voice service from the home network and maintaining data service.

17. A non-transitory computer-readable medium storing instructions executed by a processor to perform operations comprising:
receiving a notification that a wireless device has attached to a roaming public land mobile network (PLMN);
determining that the roaming PLMN is not a voice over packet switched (VoPS) network; and
deregistering the wireless device for voice services.

18. The non-transitory computer-readable medium of claim 17, the operations further determining that the wireless device has an active IMS registration prior to deregistering the wireless device.

19. The non-transitory computer-readable medium of claim 17, wherein the determining that the roaming PLMN is not a VoPs network occurs using a lookup table.

20. The non-transitory computer-readable medium of claim 17, wherein the determining that the roaming network is not a VoPs network is accomplished during an attach process of the wireless device.
